(19) United States
(12) Patent Application Publication
(10) Pub. No.: US 2026/0300111 A1
(43) Pub. Date: Oct. 1, 2026

(54) FAULT-TOLERANT SYSTEM, VOICE SERVER OPERATION METHOD, AND FAULT-TOLERANT PROGRAM

(71) Applicant: NEC Platforms, Ltd., Kanagawa (JP)

(72) Inventors: Teruo NAKAMURA, Kanagawa (JP); Kazuyoshi KUBONIWA, Kanagawa (JP); Yuji IMAI, Kanagawa (JP); Tomohiro OHNO, Kanagawa (JP)

(73) Assignee: NEC Platforms, Ltd., Kanagawa (JP)

(21) Appl. No.: 19/574,644

(22) Filed: Mar. 23, 2026

(30) Foreign Application Priority Data
Mar. 27, 2025 (JP) 2025-054206

(51) Int. Cl. G06F 11/20

(52) U.S. Cl. CPC G06F 11/2028; G06F 11/2038

(57) ABSTRACT

A fault-tolerant system includes a first voice server to which a first group ID is assigned using a card-type ExpEther device that employs ExpEther technology; a second voice server to which a second group ID is assigned using a card-type ExpEther device that employs the ExpEther technology; and a legacy equipment accommodation apparatus to which the first group ID is assigned using a box-type ExpEther device that employs the ExpEther technology, wherein the first voice server, the second voice server, and the legacy equipment accommodation apparatus are connected via an Ethernet network.

### FIELD

The present application is based upon and claims the benefit of the priority of Japanese patent application No. 2025–054206 filed on March 27, 2025, the disclosure of which is incorporated herein in its entirety by reference thereto.

The present disclosure relates to a fault-tolerant system, voice server operation method, and fault-tolerant program.

### BACKGROUND

A fault-tolerant system is a system that can continue processing normally even when a failure occurs in some of apparatuses that constitute the system (for example, refer to Patent Literature 1). FIG. 4 is a block diagram illustrating a basic configuration of a fault-tolerant system of the related art.

As shown in FIG. 4, the fault-tolerant system for voice server(s) of the related art includes a voice server system 10 installed at a central station and a backup (emergency) voice server apparatus 40 installed on a local side. The backup (emergency) voice server apparatus 40 installed on the local side, an IP telephone 46, an IP telephone 47, and an IP voice gateway apparatus 48 are connected via a local network (hub/router). Further, the voice server system 10 installed at the central station and the local network (hub/router) are connected to a VoIP network 20.

The voice server system 10 installed at the central station includes a CPU 11, a main memory 12, a storage device 13, a maintenance terminal 14, a gate apparatus 15, a LAN1 (NIC-1) 16, a LAN2 (NIC-2) 17, and a legacy equipment accommodation apparatus 18. The backup (emergency) voice server apparatus 40 installed on the local side includes a CPU 41, a main memory 42, a storage device 43, a LAN1 (NIC-1) 44, and a LAN2 (NIC-2) 45. A legacy telephone 1 and a legacy telephone 2 are connected to the legacy equipment accommodation apparatus 18.

### PTL 1

International Publication Number WO2020/241032

### SUMMARY

The disclosure of the literature cited above is incorporated herein in its entirety by reference thereto. The following analysis is provided by the present inventors.

Meanwhile, in the fault-tolerant system for voice server(s) of the related art, only IP devices such as the IP telephones and the IP voice gateway apparatus are backed up, whereas the legacy equipment cannot be when the central station becomes inoperable due to a failure or the like. The fault-tolerant system for voice server(s) of the related art communicates during normal operation as shown in FIG. 5. However, when a failure occurs in the voice server system 10 installed at the central station, the IP telephones 46 and 47, and the IP voice gateway apparatus 48 are able to continue functioning through communication with the backup (emergency) voice server apparatus 40 installed on the local side, but the legacy telephones 1 and 2 cease to function as shown in FIG. 6.

In view of the above problem, it is an object of the present disclosure to provide a fault-tolerant system, voice server operation method, and a fault-tolerant program that contribute to achieving fault tolerance even for legacy equipment installed at a local station(s).

According to a first aspect of the present disclosure, there is provided a fault-tolerant system including: a first voice server to which a first group ID is assigned using a card-type ExpEther device that employs ExpEther technology; a second voice server to which a second group ID is assigned using a card-type ExpEther device that employs the ExpEther technology; and a legacy equipment accommodation apparatus to which the first group ID is assigned using a box-type ExpEther device that employs the ExpEther technology, wherein the first voice server, the second voice server, and the legacy equipment accommodation apparatus are connected via an Ethernet network.

According to a second aspect of the present disclosure, there is provided a voice server operation method in a fault-tolerant system in which a first voice server to which a first group ID is assigned using a card-type ExpEther device that employs ExpEther technology, a second voice server to which a second group ID is assigned using a card-type ExpEther device that employs the ExpEther technology, and a legacy equipment accommodation apparatus to which the first group ID is assigned using a box-type ExpEther device that employs the ExpEther technology are connected via an Ethernet network, the voice server operation method including: when a fault occurs in the first voice server, rewriting the group ID of the legacy equipment accommodation apparatus from the first group ID to the second group ID, thereby switching control of the legacy equipment accommodation apparatus to be under control of the second voice server.

According to each aspect of the present disclosure, there can be provided a fault-tolerant system, voice server operation method, and a fault-tolerant program that contribute to achieving fault tolerance even for legacy equipment installed at a local station(s).

### BRIEF DESCRIPTION OF DRAWINGS

FIG. 1 is a block diagram illustrating a basic configuration of a fault-tolerant system of the present disclosure.

FIG. 2 is a block diagram illustrating an operating range during normal operation in the fault-tolerant system of the present disclosure.

FIG. 3 is a block diagram illustrating an operational range when a failure occurs in the fault-tolerant system of the present disclosure.

FIG. 4 is a block diagram illustrating a basic configuration of a fault-tolerant system of a conventional technology.

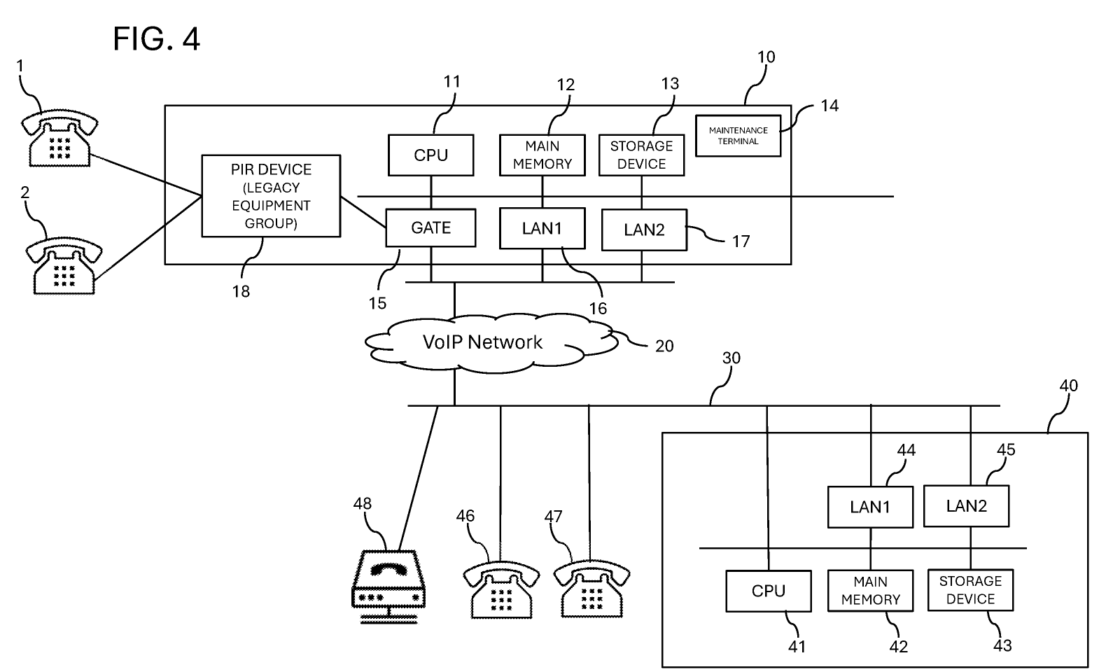

FIG. 5 is a block diagram illustrating an operating range of the fault-tolerant system of the conventional technology during normal operation.

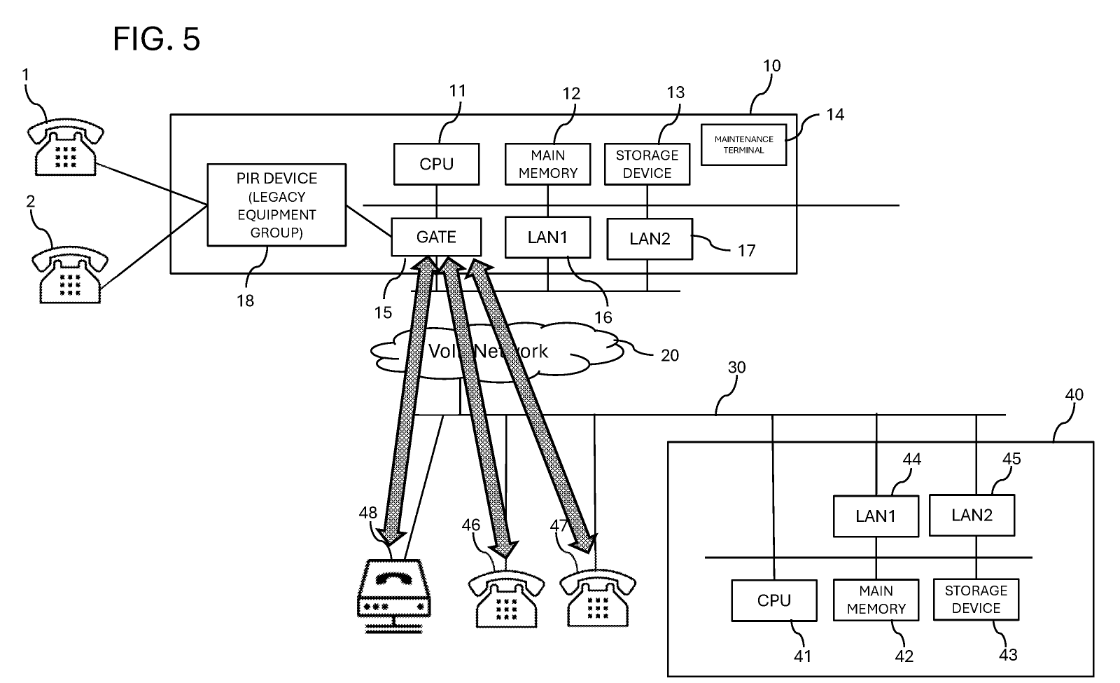

FIG. 6 is a block diagram illustrating an operating range of the fault-tolerant system of the conventional technology when a failure occurs.

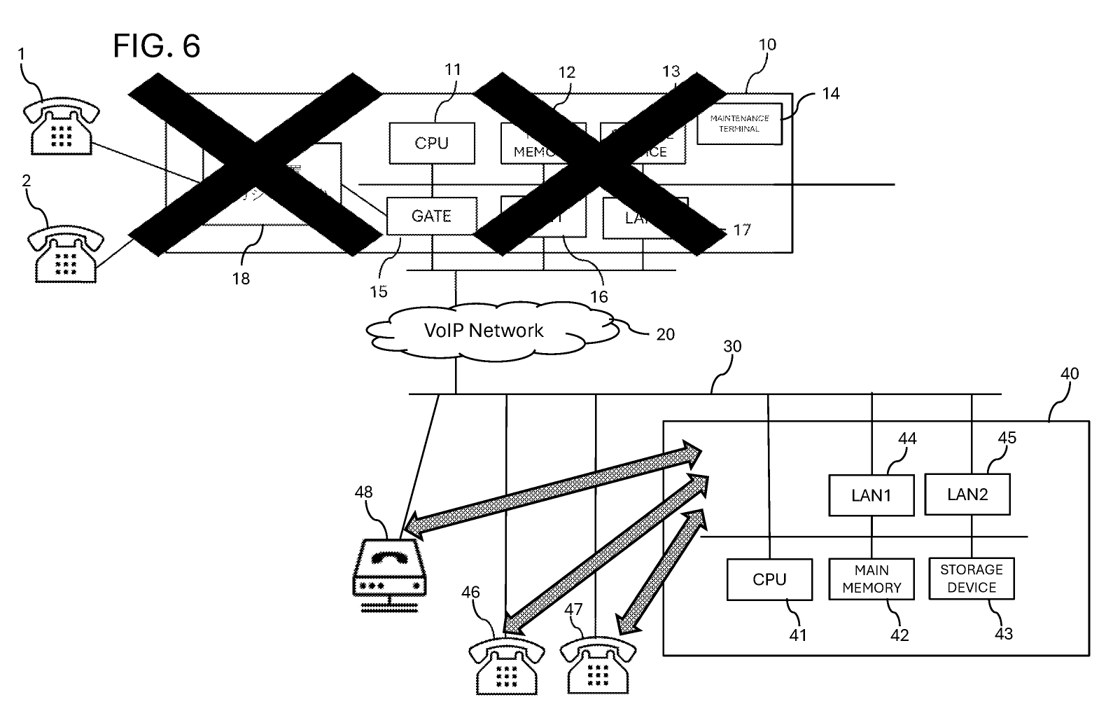

### EXAMPLE EMBODIMENTS

The following describes an example embodiment of the present disclosure with reference to the drawings. The present disclosure, however, is not limited to the example embodiment described below. Further, in each drawing, the same or corresponding elements are appropriately designated by the same reference signs. It should be noted that the drawings are schematic, and the dimensional relationships and the ratios between the elements may differ from the actual ones. The dimensional relationships and the ratios between the drawings may also be different in some sections.

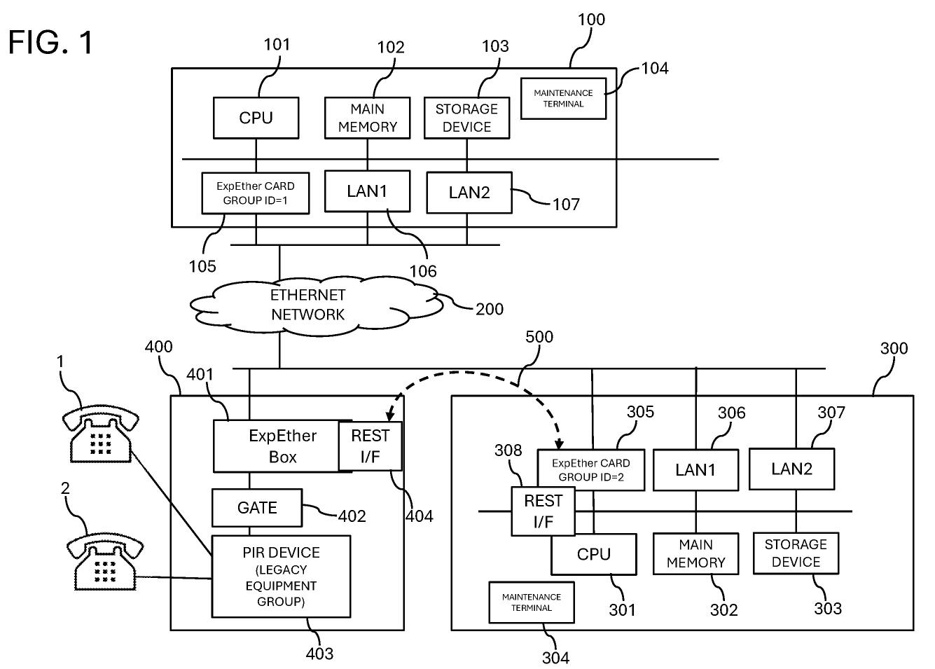

FIG. 1 is a block diagram illustrating a basic configuration of a fault-tolerant system of the present disclosure. As shown in FIG. 1, the fault-tolerant system for voice server(s) of the present disclosure includes a voice server system 100 installed at a central station, a backup (emergency) voice server apparatus 300 installed on a local side, and a legacy equipment accommodation apparatus 400 of a remote station, which are interconnected via an Ethernet network 200.

The voice server system 100 installed at the central station includes a CPU 101, a main memory 102, a storage device 103, a maintenance terminal 104, a card-type ExpEther device 105, a LAN1 (NIC-1) 106, and a LAN2 (NIC-2) 107. The backup (emergency) voice server apparatus 300 installed on the local side includes a CPU 301, a main memory 302, a storage device 303, a maintenance terminal 304, a card-type ExpEther device 305, a LAN1 (NIC-1) 306, a LAN2 (NIC-2) 307, and a REST interface device 308. The legacy equipment accommodation apparatus 400 of the remote station includes a box-type ExpEther device 401, a gate device 402, a legacy equipment accommodation device (PIR) 403, and a REST interface device 404.

A legacy telephone 1 and a legacy telephone 2 are connected to the legacy equipment accommodation device (PIR) 403 in the legacy equipment accommodation apparatus 400 of the remote station. The REST interface device 308 in the backup (emergency) voice server apparatus 300 installed on the local side and the REST interface device 404 in the legacy equipment accommodation apparatus 400 of the remote station are configured to be able to communicate with each other via a REST interface communication path.

The ExpressEther technology allows a PCI-bus device(s) to be installed on a remote station side by communicating over the PCI bus via an Ethernet network to the PCI-bus device(s). By using the ExpEther technology, the CPU 101 of the voice server system 100 installed at the central station can treat PCI device(s) connected through the Ethernet network as one(s) connected directly to its own PCI bus. In the ExpEther technology, a group ID(s) is assigned and managed in order to identify PCI device(s) installed over the Ethernet network. ExpEther communication is permitted only between a card-type ExpEther device(s) (installed on a control-side CPU) and a box-type ExpEther device(s) (a box that directly houses a PCI device(s) and is usually installed on a local side) that share the same group ID. Further, the group ID of a box-type ExpEther device(s) can be changed in real time through communication with a management server via a REST interface communication path.

By utilizing this function, it becomes possible to realize and configure a system in which a control part(s) of a PCI device(s) is provided on both the central station and a backup apparatus installed on the local side and a unique value is assigned to each of ExpEther group IDs of the central station and the backup apparatus installed on the local side, and by automatically changing the group ID(s) of a PCI device(s) (legacy equipment accommodation apparatus) upon fault detection, the system can continue to control the legacy equipment accommodation apparatus even when a failure occurs.

The CPU 101 of the voice server system 100 installed at the central station is, in advance, set to an ExpEther group ID of 1 using the maintenance terminal 104. Similarly, the backup voice server apparatus 300 installed on the local side is, in advance, set to an ExpEther group ID of 2 using the maintenance terminal 304.

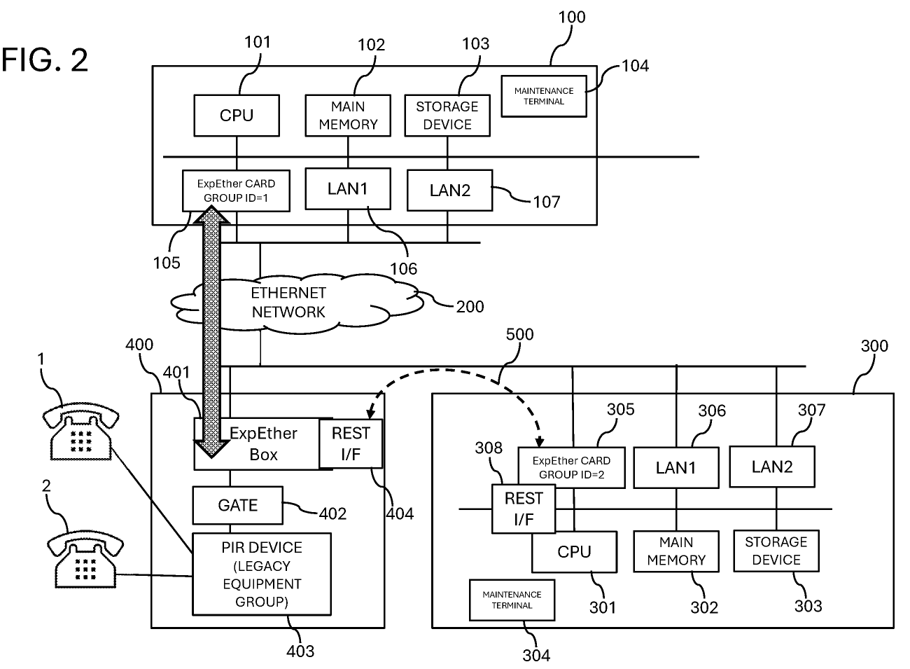

Further, the backup voice server apparatus 300 installed on the local side periodically performs health-check communication (liveness monitoring) with the voice server system 100 installed at the central station, thereby recognizing that the voice server system 100 installed at the central station is operating normally and that the group ID information (1) of the voice server system 100 installed at the central station is set. In the legacy equipment accommodation apparatus 400 installed at the local station, the same group ID information (1) as that of the central station is set through communication using the REST interface communication path 500 between the REST interface device 308 of the backup voice server apparatus 300 installed on the local side and the REST interface device 404 of the legacy equipment accommodation apparatus 400 installed at the local station. Therefore, during normal operation, as shown in FIG. 2, by setting the group ID information of 1 in the legacy equipment accommodation apparatus 400 installed at the local station, the voice server system 100 installed at the central station can recognize and control the legacy equipment accommodation apparatus 400 installed at the local station as if it were connected directly to its own PCI interface.

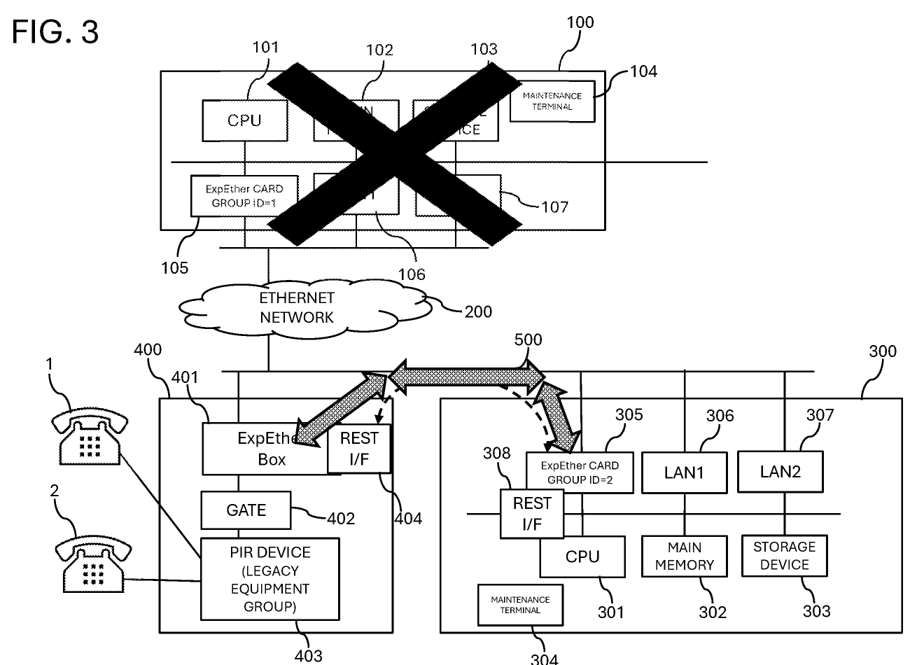

Like the voice server system 100 installed at the central station, the backup (emergency) voice server apparatus 300 installed on the local side has the card-type ExpEther device 305 for the backup voice server apparatus and periodically performs health-check communication (liveness monitoring) with the voice server system 100 installed at the central station. If no response to the health-check communication is received, the backup voice server apparatus 300 installed on the local side determines that the voice server system 100 installed at the central station has gone down. Then, through communication using the REST interface communication path 500 between the REST interface device 308 of the backup voice server apparatus 300 installed on the local side and the REST interface device 404 of the legacy equipment accommodation apparatus 400 installed at the local station, the same group ID information (2) as that of itself (the local station) is set in the legacy equipment accommodation apparatus 400 installed at the local station. As a result, as shown in FIG. 3, the legacy equipment accommodation apparatus 400 installed at the local station is switched over so that it can be controlled as a PCI device of the backup voice server apparatus 300 installed on the local side, making it possible for the backup voice server apparatus 300 installed on the local side to continue to process calls for the legacy equipment under the legacy equipment accommodation apparatus 400 installed at the local station.

Part or entirety of the example embodiment above can be described as (but not limited to) the following Supplementary Notes.

### Supplementary Note 1

A fault-tolerant system, comprising:
a first voice server to which a first group ID is assigned using a card-type ExpEther device that employs ExpEther technology;
a second voice server to which a second group ID is assigned using a card-type ExpEther device that employs the ExpEther technology; and
a legacy equipment accommodation apparatus to which the first group ID is assigned using a box-type ExpEther device that employs the ExpEther technology, wherein
the first voice server, the second voice server, and the legacy equipment accommodation apparatus are connected via an Ethernet network.

### Supplementary Note 2

The fault-tolerant system according to Supplementary Note 1, wherein
the second voice server comprises a first REST interface device,
the legacy equipment accommodation apparatus comprises a second REST interface device capable of controlling the box-type ExpEther device, and
the first REST interface device and the second REST interface device are configured to be able to communicate with each other via a REST interface communication path.

### Supplementary Note 3

The fault-tolerant system according to Supplementary Note 2, wherein
the second voice server monitors a liveness status of the first voice server, and, when a fault occurs in the first voice server, rewrites the group ID of the legacy equipment accommodation apparatus from the first group ID to the second group ID using the second REST interface device, thereby switching control of the legacy equipment accommodation apparatus to be under control of the second voice server.

### Supplementary Note 4

The fault-tolerant system according to Supplementary Note 2, wherein
the second voice server is provided in plurality, and the legacy equipment accommodating device is provided in accordance with each of the plurality of second voice servers,
when a fault occurs in communication between one of the plurality of the second server and the first voice server, the one of the plurality of the second server rewrites the group ID of the legacy equipment accommodation apparatus from the first group ID to the second group ID using the second REST interface device, thereby switching control of the legacy equipment accommodation apparatus to be under control of the one of the plurality of the second voice server.

### Supplementary Note 5

A voice server operation method, in a fault-tolerant system in which
a first voice server to which a first group ID is assigned using a card-type ExpEther device that employs ExpEther technology, a second voice server to which a second group ID is assigned using a card-type ExpEther device that employs the ExpEther technology, and a legacy equipment accommodation apparatus to which the first group ID is assigned using a box-type ExpEther device that employs the ExpEther technology are connected via an Ethernet network, the voice server operation method comprising:
when a fault occurs in the first voice server, rewriting the group ID of the legacy equipment accommodation apparatus from the first group ID to the second group ID, thereby switching control of the legacy equipment accommodation apparatus to be under control of the second voice server.

### Supplementary Note 6

The voice server operation method according to Supplementary Note 5, wherein
the second voice server is provided in plurality, and the legacy equipment accommodating device is provided in accordance with each of the plurality of second voice servers, the voice server operation method comprising:
when a fault occurs in communication between one of the plurality of the second server and the first voice server, rewriting the group ID of the legacy equipment accommodation apparatus from the first group ID to the second group ID using the second REST interface device, thereby switching control of the legacy equipment accommodation apparatus to be under control of the one of the plurality of the second voice server.

### Supplementary Note 7

The voice server operation method according to Supplementary Note 5, comprising:
monitoring a liveness status of the first voice server and determining that a fault has occurred in the first voice server.

### Supplementary Note 8

A non-transitory computer readable medium storing a fault-tolerant program for a fault-tolerant system in which
a first voice server to which a first group ID is assigned using a card-type ExpEther device that employs ExpEther technology, a second voice server to which a second group ID is assigned using a card-type ExpEther device that employs the ExpEther technology, and a legacy equipment accommodation apparatus to which the first group ID is assigned using a box-type ExpEther device that employs the ExpEther technology are connected via an Ethernet network, the program cause the second voice server to perform:
when a fault occurs in the first voice server, rewriting the group ID of the legacy equipment accommodation apparatus from the first group ID to the second group ID, thereby switching control of the legacy equipment accommodation apparatus to be under control of the second voice server.

Further, the disclosure of Patent Literature cited above is incorporated herein in its entirety by reference thereto. It is to be noted that it is possible to modify or adjust the example embodiments or examples within the scope of the whole disclosure of the present application (including Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including Claims, and the technical concept of the present invention. Particularly, any numerical values or ranges disclosed herein should be interpreted that any intermediate values or subranges falling within the disclosed ranges are also disclosed even without explicit recital thereof. In addition, using some or all of the disclosed elements in each literature cited above as necessary in combination with the elements described herein as part of the disclosure of the present invention in accordance with the object of the present invention shall be considered to be included in the disclosed elements of the present application.

### REFERENCE SIGNS LIST

1: legacy telephone

2: legacy telephone

10: voice server system installed at a central station

11: CPU

12: main memory

13: storage device

14: maintenance terminal

15: gate apparatus

16: LAN1 (NIC-1)

17: LAN2 (NIC-2)

18: legacy equipment accommodation apparatus

20: VoIP network

30: local network (hub/router)

40: backup (emergency) voice server apparatus installed on a local side

41: CPU

42: main memory

43: storage device

44: LAN1 (NIC-1)

45: LAN2 (NIC-2)

46: IP telephone

47: IP telephone

48: IP voice gateway apparatus

100: voice server system installed at a central station

101: CPU

102: main memory

103: storage device

104: maintenance terminal

105: card-type ExpEther device

106: LAN1 (NIC-1)

107: LAN2 (NIC-2)

200: Ethernet network

300: backup (emergency) voice server apparatus installed on a local side

301: CPU

302: main memory

303: storage device

304: maintenance terminal

305: card-type ExpEther device

306: LAN1 (NIC-1)

307: LAN2 (NIC-2)

308: REST interface device

400: legacy equipment accommodation apparatus

401: box-type ExpEther device

402: gate device

403: legacy equipment accommodation device (PIR)

404: REST interface device

500: REST interface communication path

What is claimed is:

1. A fault-tolerant system, comprising:
a first voice server to which a first group ID is assigned using a card-type ExpEther device that employs ExpEther technology;
a second voice server to which a second group ID is assigned using a card-type ExpEther device that employs the ExpEther technology; and
a legacy equipment accommodation apparatus to which the first group ID is assigned using a box-type ExpEther device that employs the ExpEther technology, wherein
the first voice server, the second voice server, and the legacy equipment accommodation apparatus are connected via an Ethernet network.

2. The fault-tolerant system according to claim 1, wherein
the second voice server comprises a first REST interface device,
the legacy equipment accommodation apparatus comprises a second REST interface device capable of controlling the box-type ExpEther device, and
the first REST interface device and the second REST interface device are configured to be able to communicate with each other via a REST interface communication path.

3. The fault-tolerant system according to claim 2, wherein
the second voice server monitors a liveness status of the first voice server, and, when a fault occurs in the first voice server, rewrites the group ID of the legacy equipment accommodation apparatus from the first group ID to the second group ID using the second REST interface device, thereby switching control of the legacy equipment accommodation apparatus to be under control of the second voice server.

4. The fault-tolerant system according to claim 2, wherein
the second voice server is provided in plurality, and the legacy equipment accommodating device is provided in accordance with each of the plurality of second voice servers,
when a fault occurs in communication between one of the plurality of the second server and the first voice server, the one of the plurality of the second server rewrites the group ID of the legacy equipment accommodation apparatus from the first group ID to the second group ID using the second REST interface device, thereby switching control of the legacy equipment accommodation apparatus to be under control of the one of the plurality of the second voice server.

5. A voice server operation method, in a fault-tolerant system in which
a first voice server to which a first group ID is assigned using a card-type ExpEther device that employs ExpEther technology, a second voice server to which a second group ID is assigned using a card-type ExpEther device that employs the ExpEther technology, and a legacy equipment accommodation apparatus to which the first group ID is assigned using a box-type ExpEther device that employs the ExpEther technology are connected via an Ethernet network, the voice server operation method comprising:
when a fault occurs in the first voice server, rewriting the group ID of the legacy equipment accommodation apparatus from the first group ID to the second group ID, thereby switching control of the legacy equipment accommodation apparatus to be under control of the second voice server.

6. The voice server operation method according to claim 5, wherein
the second voice server is provided in plurality, and the legacy equipment accommodating device is provided in accordance with each of the plurality of second voice servers, the voice server operation method comprising:
when a fault occurs in communication between one of the plurality of the second server and the first voice server, rewriting the group ID of the legacy equipment accommodation apparatus from the first group ID to the second group ID using the second REST interface device, thereby switching control of the legacy equipment accommodation apparatus to be under control of the one of the plurality of the second voice server.

7. The voice server operation method according to claim 5, comprising:
monitoring a liveness status of the first voice server and determining that a fault has occurred in the first voice server.

8. A non-transitory computer readable medium storing a fault-tolerant program for a fault-tolerant system in which
a first voice server to which a first group ID is assigned using a card-type ExpEther device that employs ExpEther technology, a second voice server to which a second group ID is assigned using a card-type ExpEther device that employs the ExpEther technology, and a legacy equipment accommodation apparatus to which the first group ID is assigned using a box-type ExpEther device that employs the ExpEther technology are connected via an Ethernet network, the program cause the second voice server to perform:
when a fault occurs in the first voice server, rewriting the group ID of the legacy equipment accommodation apparatus from the first group ID to the second group ID, thereby switching control of the legacy equipment accommodation apparatus to be under control of the second voice server.
